(19) United States
(12) Patent Application Publication
(10) Pub. No.: US 2008/0137529 A1
(43) Pub. Date: Jun. 12, 2008

(54) Method and apparatus for diagnosing VoIP-related communication faults

(75) Inventors: Mujeeb Sheikh, Morganville, NJ (US); Thomas E. McGrath, Old Bridge, NJ (US); Brian D. Pante, Belle Mead, NJ (US); Jose Martinez, Perth Amboy, NJ (US); Michael Vicari, Edison, NJ (US); Troy Nelson, Plainfield, NJ (US); Anthony Kuzmicki, Old Bridge, NJ (US)

Correspondence Address: VONAGE, 23 MAIN STREET, HOLMDEL, NJ, 07733, US

(73) Assignee: Vonage Network Inc.

(21) Appl. No.: 11/999,982

(22) Filed: Dec. 6, 2007

Related U.S. Application Data
(60) Provisional application No. 60/873,613, filed on Dec. 8, 2006.

(51) Int. Cl. H04L 12/24; H04L 12/26

(52) U.S. Cl. 370/216; 370/242

(57) ABSTRACT

Method and system for diagnosing communication faults in a Voice over Internet Protocol (VoIP) session includes responding to a creation of a first interface by a customer of a VoIP service to a VoIP service provider, creating a second interface between the customer and the VoIP service provider, initiating a diagnostic tool from the second interface, providing a plurality of reports based on results of the diagnostic tool and the end viewer of such reports; and providing a solution to the communication fault. The second interface is created by instructing the customer to launch a web-based application via the first interface. Alternately, instructions to the customer are provided via means other than the first interface such as voicemail, email or Instant Message. The diagnostic tool is initiated by the customer entering basic information regarding a corresponding customer account.

The application claims the benefit of U.S. Provisional Application No. 60/873,613, filed Dec. 8, 2006.

### FIELD OF THE INVENTION

The invention is related to the field of telecommunication devices and services and more specifically, the invention is directed to a method and apparatus for diagnosing and statistically evaluating communication faults in a Voice over Internet Protocol (VoIP) telecommunication system.

### BACKGROUND OF THE INVENTION

VoIP is a technological development in the field of telecommunications that is utilized to transmit voice communications over a data network using the Internet Protocol (IP) rather than the existing and traditional telecommunications system more commonly referred to as the Public Switched Telephone Network (PSTN) or Plain Old Telephone Service (POTS). Entities (e.g., businesses or individuals) implement VoIP by purchasing and installing the necessary equipment (e.g., one or more Customer Premise Equipment (CPE) devices) to access a VoIP service provider and activating this telecommunication service via a broadband connection.

Since VoIP is a relatively new technology in terms of its commercial penetration, there may be unseen technical issues with the CPE, network or other system components that may result in communication faults (lack of capability to make a phone call, unintended disconnection of phone call, poor voice quality and the like). Such a condition requires communication between an entity and the VoIP service provider in a “customer service” or “technical assistance” type of interaction. Historically, these types of interactions are not enviable or enjoyable for either party. Frequently, the customer lacks the technical vocabulary or ability to express the nature of the communication fault. The service provider incurs increased costs of business operations by having to employ a staff of technical agents to process such types of communications. Therefore, there is a need in the art for a method and apparatus for providing VoIP service providers and their customers with an improved customer service experience that also reduces operational costs when confronted with the diagnosing of communication faults.

### SUMMARY OF THE INVENTION

The disadvantages associated with the prior art are overcome by a method and system for diagnosing communication faults in a Voice over Internet Protocol (VoIP) communication. The invention provides a method that includes the steps of responding to a creation of a first interface by a customer of a VoIP service to a corresponding VoIP service provider responsible for executing VoIP sessions, creating a second interface between the customer and the VoIP service provider, initiating a diagnostic tool from the second interface, providing a plurality of reports based on results of the diagnostic tool and the end viewer of such reports; and providing a solution to the communication fault. The second interface is created by instructing the customer to launch a web-based application via the first interface. Alternately, instructions to the customer are provided via means other than the first interface such as voicemail, email or Instant Message. The first interface may be non-web-based and the second interface may be web-based. The diagnostic tool is initiated by the customer entering basic information regarding a corresponding customer account; the basic information selected from the group consisting of a phone number associated with the communication fault, a customer account number and a Media Access Control (MAC) address of customer equipment associated with the communication fault.

A corresponding system for diagnosing communication faults in a VoIP session includes a first interface means between a VoIP service provider and a VoIP customer, a second interface means between VoIP service provider equipment and VoIP customer equipment, a computer architecture connected to the second interface means and adapted to provide communication between the VoIP service provider equipment, the VoIP customer equipment and the computer architecture wherein the computer architecture includes a module for performing diagnostic tool execution and reporting analysis of the communication fault via the second interface and based on VoIP customer input. Computer readable medium for storing a software program that, when executed by a computer and being initiated in response to the creation of a first interface by a customer of a VoIP service to a corresponding VoIP service provider responsible for executing VoIP sessions operating in accordance with the above-described method is also contemplated.

### BRIEF DESCRIPTION OF THE FIGURES

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a series of method steps for diagnosing VoIP-related communication faults in accordance with the subject invention;

FIG. 2 depicts a system for diagnosing VoIP-related communication faults in accordance with the subject invention;

FIG. 3 depicts an organizational overview of a suite of diagnostic tools used in accordance with the subject invention; and

FIG. 4 depicts a schematic diagram of a controller that may be used to practice the method of the subject invention.

To facilitate understanding, identical reference numerals have been used, where possible, to designate identical elements that are common to the figures.

### DETAILED DESCRIPTION

To achieve the desired objectives, the invention brings a VoIP customer and a VoIP service provider together in a communication session that is capable of analyzing a customer's complaint. The session is easily initiated by the customer and the customer need only take easy to follow, non-technical steps to launch a suite of diagnostic tools that determines customer connectivity and network status in order to diagnose the source of a problem (i.e., a communication fault). The diagnostic tool, in turn, provides the service provider with the necessary information to correct the communication fault or otherwise improve the customer's experience by providing recommendations or the like.

In a preferred embodiment of the invention, the apparatus that accomplishes this diagnostic method is one or more components of a VoIP communication system. Such communication system is, by way of example, part of any public or private data network (or combination thereof) constructed for (in part) and adapted to convert analog voice signals (e.g., generated by a human utterance) to a digitized and packetized format according to known and understood protocols (such as but not limited to Transmission Control Protocol/Internet Protocol (TCP/IP)) for transmission from an originating point (Party A) to one or more terminating points (Party B and/or C, D and the like). In an embodiment of the invention, the data network is an IP-based network such as (but not limited to) the Internet having VoIP specific and related components connected thereto.

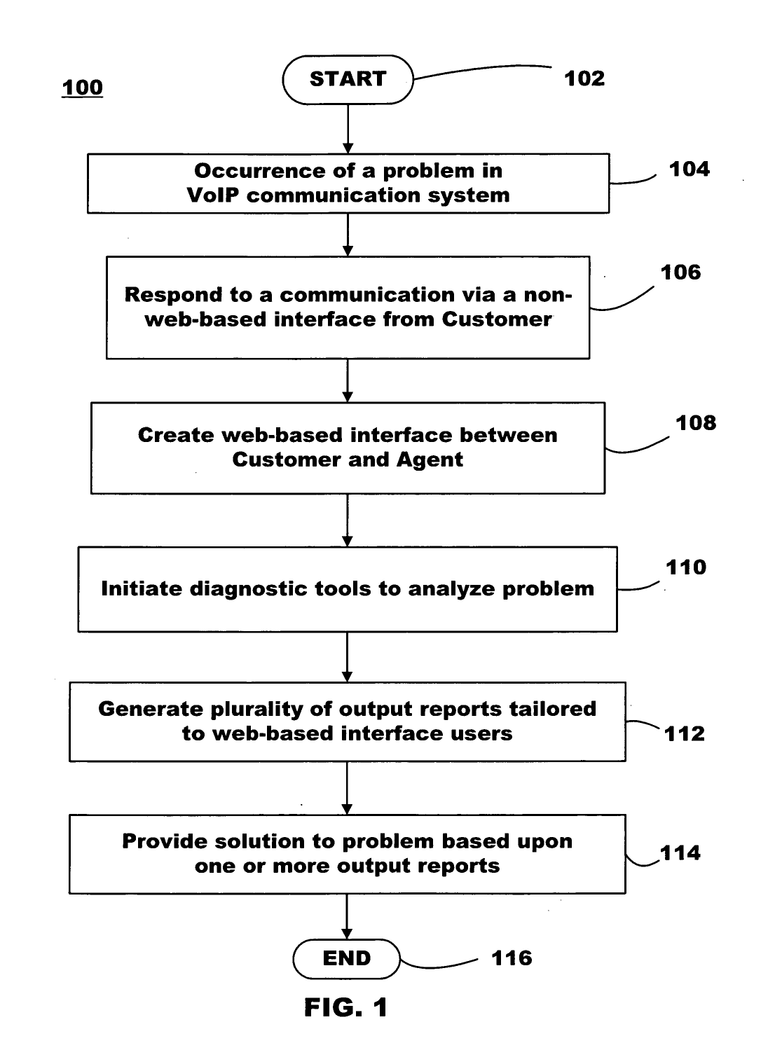

FIG. 1 depicts a series of method steps 100 for performing diagnostic operations in accordance with the subject invention. The diagnostic method 100 starts at step 102 and proceeds to step 104 where there is an occurrence of a problem in the VoIP communication system. Particularly, a customer has trouble in the form of a communication fault including but not limited to establishing an outgoing phone call, receiving an incoming phone call, realizing a decrease in voice quality of an existing phone call or other type of communication fault that reduces the experience with the service. The problem is selected from the group consisting of a CPE problem and a network status problem. CPE problems include problems related to actual CPE malfunction (i.e., an improper/malfunctioning codec or codec setting) improper installation or use of CPE by the customer and poor/improper customer infrastructure (i.e., home/internal wiring). Network status problems include problems related to a non-operational node in the communication pathway, an improper or poor bandwidth condition at some point in the communication pathway, an improper or malfunctioning jitter buffer at some point in the communication pathway and/or full or partial loss of the broadband connection (i.e., to the Internet).

At step 106, a first interface is created between the customer and a service provider proxy. By way of non-limiting definition, the term proxy is taken as a representative of the VoIP service provider. Such representative may take the form of a human service provider agent or an electronic/automated Interactive Voice Response system (IVR). The first interface establishes the first part of a diagnostic session between these two parties to address the occured problem. In one embodiment of the invention, the first interface is a non-web-based interface (i.e., a phone call placed by the customer to the service provider and relayed to an appropriate human service provider agent). The type of phone call is selected from the group consisting of a PSTN phone call and a VoIP phone call from a line other than the line on which the problem was occured. The service provider agent will then use this non-web-based interface to be responsive to a communication established therewithin to determine the basic nature of the problem that has occured.

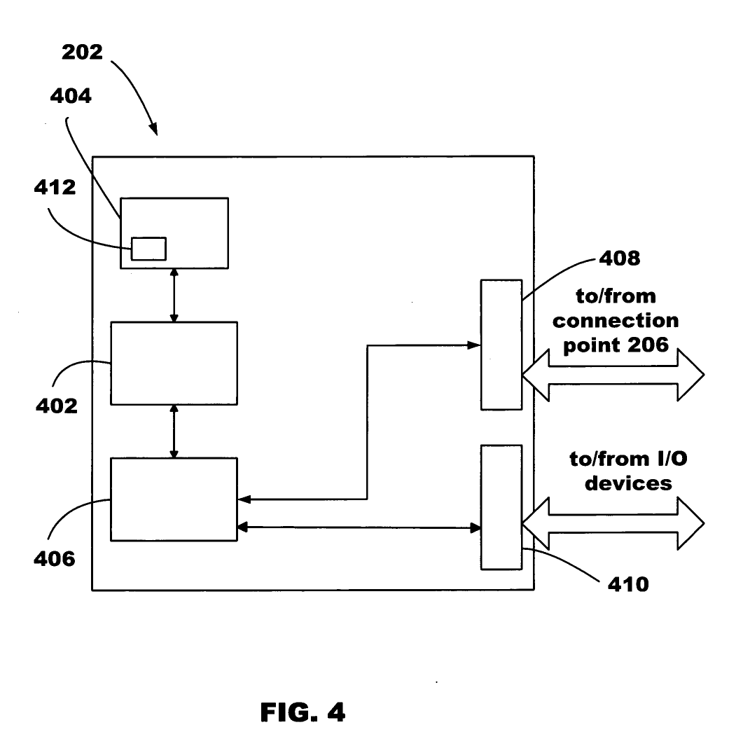

At step 108, a second interface is created between the customer and a service provider proxy. The second interface establishes the second part of a diagnostic session between these two parties to address the occured problem. More specifically, upon responding to and interacting with the customer via the first interface, the service provider proxy determines that a detailed technical examination is necessary to complete analysis of the occured problem. Accordingly, the service provider proxy instructs the customer to go to a website and launch a web-based application. The instruction may be part of the first interface (i.e., part of the existing phone call) or any other suitable method of conveying the instructions such as, but not limited to a voicemail, an email, an Instant Message or the like. The web-based application is, in one embodiment of the invention, a suite of diagnostic tools that examines various VoIP related system parameters and conditions so as to narrow the scope of or otherwise define the specific nature of the occured problem. Thus, in one embodiment of the invention, the second interface is a web-based interface (i.e., a computer program or software that is explained in greater detail below with respect to FIG. 4). Preferably, the web-based interface includes an active component and a passive component. The active component includes the actual session interaction between the customer and the service provider proxy (i.e., customer input of data and service provider proxy interpretation of data). The passive component includes an archiving activity that collects information relevant to the session (explained in greater detail below) and organizes it for future evaluation and statistical analysis. Such analysis is conducted by the service provider or by a third party having knowledge of the service provider's technology and system.

Once the web-based application is launched, the customer follows plain language requests and prompts for basic information and submits such information to begin the technical examination at step 110. That is, the customer is able to provide specific information about the phone line that is affected by the occured problem and then let the web-based application and service provider proxy perform the technical examination without further input. Such basic information is selected from the group consisting of the phone number of the effected line (also known as the Direct Inbound Dialed or DID number), customer account number and Media Access Control (MAC) address of the CPE. That is, each CPE has a unique physical identifier that the network associates with a logical address on the network. Knowing such physical identifier provides a more complete picture of what is occurring at a given location in the network. This provides a more beneficial session for the customer because the customer does not have to try and explain further technical problems that may be outside of his scope of understanding. Further, this also provides a more beneficial session for the service provider proxy because the service provider proxy can simply follow the web-based application analysis to eliminate possible reasons for the occured problem based on factual evidence rather than guess as to what the customer may be attempting to express as the problem.

At step 112, the analysis executed by the web-based application is completed and the results are provided in a manner that is tailored to the specific users of the web-based application. In other words, a plurality of output reports are provided to a plurality of web-based application users based on the user's specific needs to see the information contained in such reports. For example, the customer is not interested in knowing the detailed technological reasons for the problem; thus, he only needs to be shown an output report that identifies where the problem is located and who is responsible for fixing the problem. Accordingly, a display of such information is provided to the customer on his computer where he initially launched the web-based application. In one embodiment of the invention, such a report is shown as a simple graphical depiction of various points in the system (or a single point in the system) where the cause of the problem is determined to exist. Similarly, the service provider proxy needs to see more detailed information regarding the actual results of each of the diagnostic tools that were run in the suite in order to make a final determination regarding how to proceed with fixing the problem. A discussion of each tool and the output report provided to the active component of the service provider proxy is discussed in greater detail below. Additionally, the passive component of the service provider proxy component receives a different output report than the customer or the active component of the service provider proxy. That is, the archiving of the details of the analysis allow a greater amount of data to be simply stored and reviewed in part or in whole at a later date according to any number of different reasons or statistical studies about the network or recurrence of similar problems. Accordingly, the passive component of the service provider proxy is provided with an output report having a more comprehensive collection of data than the active component of the service provider proxy or the customer and is not necessarily organized, formatted or displayed for easy viewing or reading on an output display as mentioned above.

At step 114, a solution to the occured problem is provided based on one or more of the output reports. That is, the service provider proxy reviews a corresponding service provider proxy output report to determine the specific nature or source of the occured problem. If the output report indicates that the problem has occurred because of a system malfunction located anywhere but at the customer site, the service provider proxy can dispatch a service notice for that system location so that the necessary repairs can take place. Alternately, the service provider proxy can change settings in a customer configuration file so that the CPE reacts differently to the external network and system (i.e., avoiding certain nodes or otherwise re-routing traffic from the customer location). Such configuration file settings include but are not limited to changing codec settings, adjusting bandwidth settings and adjusting jitter buffer settings. Other solutions are known to those skilled in the art and are considered within the scope of the invention. If the output report indicates that the problem has occurred at the customer site, the service provider proxy directs the customer on any number of possible solutions that the customer can undertake to solve the problem. Such solutions are selected from the group consisting of having the customer change or adjust a CPE setting (such as but not limited to the configuration file settings discussed above), having the customer replace defective CPE, having the customer repair or replace existing customer premises infrastructure (i.e., internal wiring). Other solutions are known to those skilled in the art and are considered within the scope of the invention. After step 114, the method 100 ends at step 116.

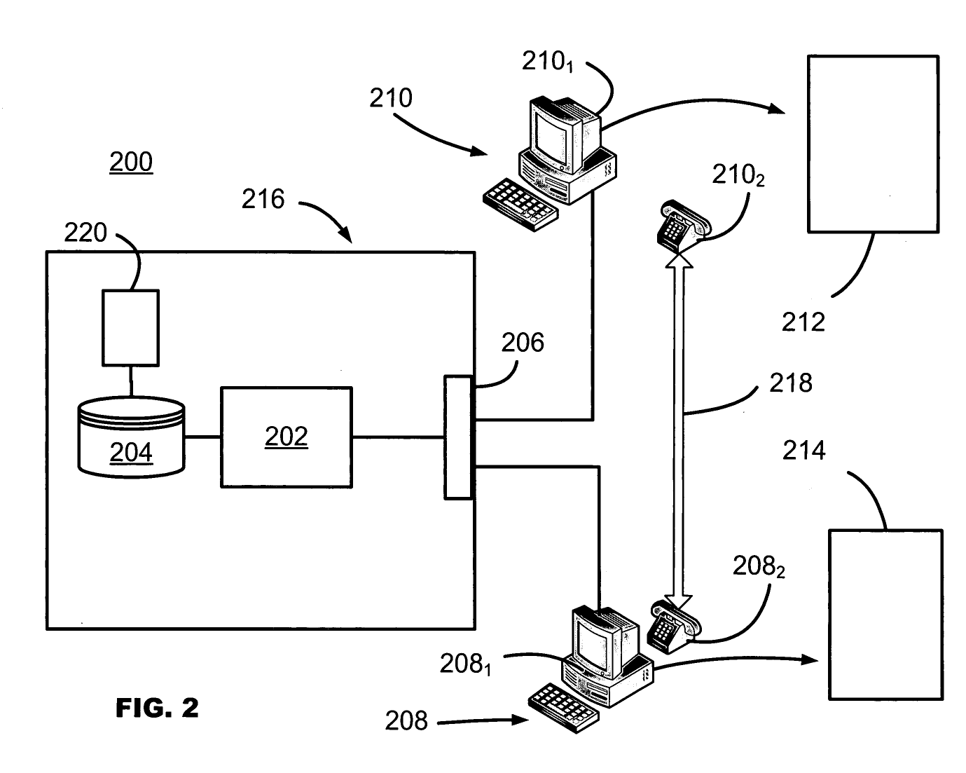

FIG. 2 depicts a system 200 for practicing the method of diagnosing VoIP-related communication faults in accordance with the subject invention. The system 200 includes at least one diagnostic tool server 216 and a plurality of service provider proxy 210 and customer 208 equipment that facilitates establishment of the interfaces described earlier. Specifically, the system 200 comprises at least one server 216 through which a majority of the diagnostic analysis and interfacing functions are executed. The server 216 further comprises a controller 202 that controls the operations of the server 216 as, for example, the method 100 of FIG. 1 is practiced and explained in greater detail below. A database or similar type of storage device 204 is connected to the controller 202 for storing information related to the diagnostic analysis. Such information includes but is not limited to customer name and DID, diagnostic test parameters and detailed information regarding the execution of each diagnostic tool in the suite and output reports of either or both of the customer and service provider proxy active component and specifically the output report of the service provider proxy passive component.

In one embodiment of the invention, the database 204 is a separate and discrete component apart from the server 216; in a second embodiment, database 204 is an integrated part of the server 216. Additionally, the database 204 includes a view function 220 that enables viewing of data collected during various tool executions for statistical analysis of problems and the like. One example of a suitable database 204 is the one of the products developed and marketed by MySQL AB of Uppsala, Sweden. The server 216 further comprises a connection point 206 adapted to provide communication between the service provider proxy equipment 210, customer equipment 208 and the server 216 and to perform diagnostic analysis of customer equipment and the communication system attached thereto.

Service provider proxy equipment 210 and customer equipment 208 includes specific devices for establishing each of the aforementioned non-web-based and web-based interfaces. In a preferred embodiment of the invention, a non-web-based interface 218 such as the one described above is established by interconnection of a customer telephone 2082 and a service provider proxy telephone 2102 when the customer first detects the problem and contacts the service provider. In a preferred embodiment of the invention, a web-based interface 212/214 such as the one described above is established by interconnection of a customer personal computer (PC) 208₁ and a service provider proxy terminal 210₁ when the service provider proxy instructs the customer to launch the web-based application (suite of diagnostic tools). That is, one or more pages 212/214 of web-based information is displayed at the customer PC 208₁ and a service provider proxy terminal 210₁ to represent the establishment of the web-based interface.

A customer may see pages including but not limited to a start up or welcome page, a diagnostic analysis query page and an output report page. The welcome page confirms proper launching of the web-based application, the diagnostic query page requests information specific to the customer necessary to start the diagnostic analysis and the output report page displays the results of the diagnostic analysis. Other pages may be included to improve or support the described pages. A service provider proxy may see pages including but not limited to a start up or welcome page, a diagnostic analysis status page and an output report page. The welcome page confirms proper launching of the web-based application, the diagnostic analysis status displays information specific to the customer's connection and individual tools and tests being performed to analyze the problem and the output report page displays the results of the diagnostic analysis. Other pages may be included to improve or support the described pages.

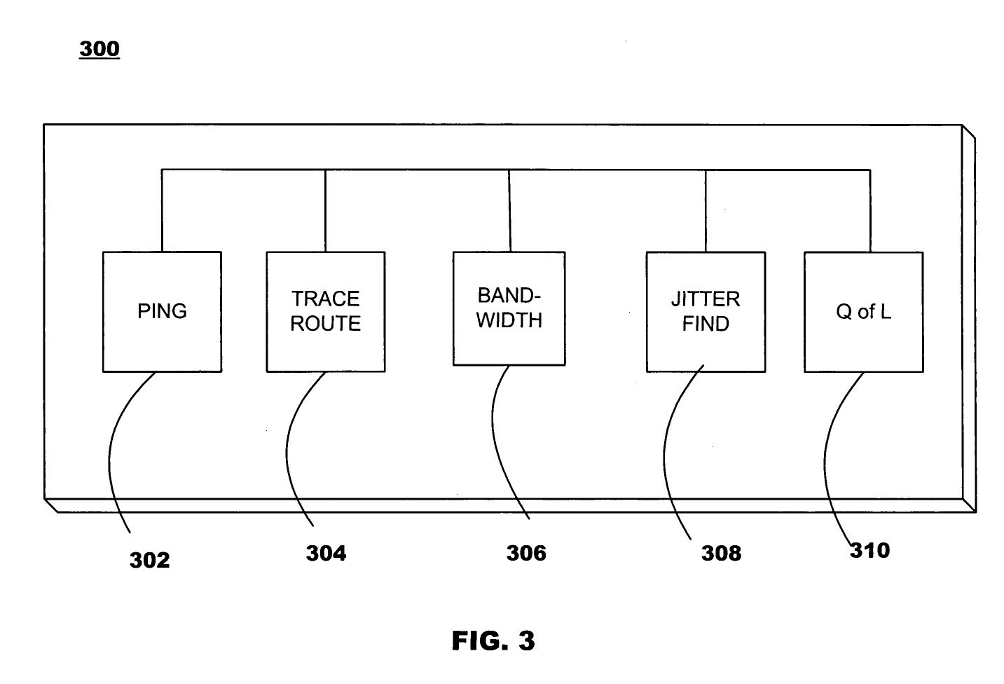

As described earlier, a suite of diagnostic tools are employed to analyze the occured problem and assist in providing the multimode output reports. FIG. 3 depicts an organizational overview chart of the suite 300 of diagnostic tools for increased clarity as to what occurs during the diagnostic analysis. Specifically, the suite 300 is comprised of a plurality of tool modules 302-310. Each tool module is capable of executing a specific diagnostic test on the communication system so as to create a better understanding of what/where the occured problem is. A first tool module 302 (entitled PING) tests for nodal activity. That is, each VoIP communication traverses a communication path comprised of a set of nodes across a communication network. If one of the nodes in the path fails or is otherwise unable to properly operate according to network protocols, the VoIP communication will not establish itself (or be able to continue depending on the particular session status). Accordingly, PING will be able to determine if there is a problem connecting between two endpoints over the broadband connection. An example of PING may be found in the operating systems of common and popular personal computers (PCs) such as those running the Windows XP operating system manufactured and sold by Microsoft Corporation of Redmond, Wash., USA. For example, one can enter “ping www.yahoo.com” from a command line on a Windows XP-based PC. Alternately, “ping” commands can be found by entering “ping /?” at the command line of a typical DOS prompt environment.

A second tool module 304 (entitled TRACE ROUTE) tests for network protocol compliance across the entire intended path of the VoIP communication. If one or more path conditions of the intended path are not in compliance, TRACE ROUTE will be able to determine what aspects of the intended path are causing the occured problem. An example of TRACE ROUTE may be found in the operating systems of common and popular personal computers (PCs) such as those running the Windows®^{XP} operating system manufactured and sold by Microsoft Corporation of Redmond, Wash., USA. For example, one can enter “tracert” from a command line prompt on a Windows XP-based PC.

A third tool module 306 (entitled BANDWIDTH) tests bandwidth conditions through various points in the communication network. If one or more network points have insufficient bandwidth to carry the load of VoIP communications (hence degrade performance or undesirably end one or more communications prematurely), BANDWIDTH will be able to determine where such bandwidth conditions exist.

A fourth tool module 308 (entitled JITTER FINDER) tests conditions between multiple network nodes along the communication path of the VoIP communication. If one or more nodes have insufficient timing/buffering capabilities to process the VoIP communication (hence degrade performance or undesirably end one or more communications prematurely), JITTER FINDER will be able to determine where such jitter buffer conditions exist.

A fifth tool module 310 (entitled QUALITY of LINE) evaluates the overall quality of the phone line (communication path) being tested based upon the four previous tools. By using a third party website, service provider proxys can graphically view line quality. An example of QUALITY of LINE may be found at the website www.testmyvoip.com. Specifically, this module will call a routine to be run to achieve the desired evaluation of the previous tools.

FIG. 4 depicts a schematic diagram of the controller 202 that may be used to practice the present invention. The controller 202 may be used to facilitate establishment of the web-based interface and control of the system 200 described above. The controller 202 may be one of any form of a general purpose computer processor used in accessing an IP-based network such as a corporate intranet, the Internet or the like. The controller 202 comprises a central processing unit (CPU) 402, a memory 404, and support circuits 406 for the CPU 402. The controller 202 also includes provisions 408/410 for connecting the controller 202 to the customer equipment 208 and service provider proxy equipment 210 and the one or more input/output devices (not shown) for accessing the controller 202 and/or performing ancillary or administrative functions related thereto. Note that the provisions 408/410 are shown as separate bus structures in FIG. 4; however, they may alternately be a single bus structure without degrading or otherwise changing the intended operability of the controller 202 or invention in general. Additionally, the controller 202 and its operating components and programming as described in detail below are shown as a single entity; however, the controller may also be one or more controllers and programming modules interspersed around the system 200 each carrying out a specific or dedicated portion of the diagnostic analysis as described earlier. By way of non-limiting example, a portion of the controller 202 or software operations may occur at the server 216 and another a portion of the controller 202 or software operations may occur at the service provider proxy equipment 210. Other configurations of the controller and controller programming are known and understood by those skilled in the art.

The memory 404 is coupled to the CPU 402. The memory 404, or computer-readable medium, may be one or more of readily available memory such as random access memory (RAM), read only memory (ROM), floppy disk, hard disk, flash memory or any other form of digital storage, local or remote. The support circuits 406 are coupled to the CPU 402 for supporting the processor in a conventional manner. These circuits include cache, power supplies, clock circuits, input/output circuitry and subsystems, and the like. A software routine 412, when executed by the CPU 402, causes the controller 202 to perform processes of the present invention and is generally stored in the memory 404. The software routine 412 may also be stored and/or executed by a second CPU (not shown) that is remotely located from the hardware being controlled by the CPU 402.

The software routine 412 is executed when a preferred method of diagnosing VoIP related communication faults is desired. The software routine 412, when executed by the CPU 402, transforms the general purpose computer into a specific purpose computer (controller) 202 that controls the web-based application, suite of diagnostic tools or other similar actions. Although the process of the present invention is discussed as being implemented as a software routine, some of the method steps that are disclosed therein may be performed in hardware as well as by the software controller. As such, the invention may be implemented in software as executed upon a computer system, in hardware as an application specific integrated circuit or other type of hardware implementation, or a combination of software and hardware. The software routine 412 of the present invention is capable of being executed on computer operating systems including but not limited to Microsoft Windows 98, Microsoft Windows XP, Apple OS X and Linux. Similarly, the software routine 412 of the present invention is capable of being performed using CPU architectures including but not limited to Apple Power PC, Intel x86, Sun service provider agentRC and Intel ARM.

While foregoing is directed to embodiments of the present invention, other and further embodiments of the invention may be devised without departing from the basic scope thereof, and the scope thereof.

What is claimed is:

1. A method for diagnosing communication faults in a Voice over Internet Protocol (VoIP) session comprising:
responding to a communication, the communication occurring via a first interface by a customer of a VoIP service to a corresponding VoIP service provider responsible for executing VoIP sessions;
creating a second interface between the customer and the VoIP service provider;
initiating a diagnostic tool from the second interface;
generating a plurality of reports based on results of the diagnostic tool and the end viewer of such reports; and
providing a solution to the communication fault.

2. The method of claim 1 wherein the second interface is created by instructing the customer to launch a web-based application via the first interface.

3. The method of claim 2 wherein instructions to the customer are provided via means other than the first interface.

4. The method of claim 3 wherein means other than the first interface is selected from the group consisting of voicemail, email and Instant Message.

5. The method of claim 1 wherein the first interface is non-web-based.

6. The method of claim 1 wherein the second interface is web-based.

7. The method of claim 1 wherein the diagnostic tool is initiated by the customer entering basic information regarding a corresponding customer account; the basic information selected from the group consisting of a phone number associated with the communication fault, a customer account number and a Media Access Control (MAC) address of customer equipment associated with the communication fault.

8. The method of claim 1 wherein the end viewer of the plurality of reports is selected from the group consisting of the customer and a VoIP provider proxy.

9. The method of claim 1 wherein the solution further comprises a VoIP provider proxy taking specific action based on the plurality of reports; the specific action selected from the group consisting of dispatching a service notice, changing settings in a customer configuration file and directing the customer to take an action.

10. A computer readable medium storing a software program that, when executed by a computer and being initiated in response to a communication occurring via a first interface by a customer of a VoIP service to a corresponding VoIP service provider responsible for executing VoIP sessions, causes the computer to perform an operation of diagnosing communication faults in a Voice over Internet Protocol (VoIP) session, the operation comprising:
creating a second interface between the customer and the VoIP service provider;
initiating a diagnostic tool from the second interface;
generating a plurality of reports based on results of the diagnostic tool and the end viewer of such reports; and
providing a solution to the communication fault.

11. The method of claim 10 wherein the second interface is created by instructing the customer to launch a web-based application via the first interface.

12. The method of claim 11 wherein instructions to the customer are provided via means other than the first interface.

13. The method of claim 12 wherein means other than the first interface is selected from the group consisting of voicemail, email and Instant Message.

14. The method of claim 10 wherein the first interface is non-web-based.

15. The method of claim 10 wherein the second interface is web-based.

16. The method of claim 10 wherein the diagnostic tool is initiated by the customer entering basic information regarding a corresponding customer account; the basic information selected from the group consisting of a phone number associated with the communication fault, a customer account number and a Media Access Control (MAC) address of customer equipment associated with the communication fault.

17. The method of claim 10 wherein the end viewer of the plurality of reports is selected from the group consisting of the customer and a VoIP provider proxy.

18. The method of claim 10 wherein the solution further comprises a VoIP provider proxy taking specific action based on the plurality of reports; the specific action selected from the group consisting of dispatching a service notice, changing settings in a customer configuration file and directing the customer to take an action.

19. A system for diagnosing communication faults in a VoIP session comprising:
a first interface means between a VoIP service provider and a VoIP customer;
a second interface means between VoIP service provider equipment and VoIP customer equipment;
a computer architecture connected to the second interface means and adapted to provide communication between the VoIP service provider equipment, the VoIP customer equipment and the computer architecture;
the computer architecture including a module for performing diagnostic tool execution and reporting analysis of the communication fault via the second interface and based on VoIP customer input.

20. The system of claim 19 wherein the first interface means is non-web-based.

21. The system of claim 20 wherein the first interface means is a telephonic interface.

22. The system of claim 19 wherein the second interface is web-based.

23. The system of claim 22 wherein the second interface is an interconnection of a VoIP customer computer and a VoIP service provider proxy terminal created when the VoIP customer launches a web-based application.

24. The system of claim 23 wherein the web-based application is a suite of diagnostic tools.

25. The system of claim 23 wherein the diagnostic tools are selected from the group consisting of PING, TRACE ROUTE, BANDWIDTH, JITTER FINDER AND QUALITY of LINE.
